(19) United States
(12) Patent Application Publication
(10) Pub. No.: US 2008/0100960 A1
(43) Pub. Date: May 1, 2008

(54) Wafer and insulation characteristic monitoring method

(75) Inventors: Masahiro Kakehi, Kawasaki (JP); Ryuei Ono, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/731,558

(22) Filed: Mar. 30, 2007

(30) Foreign Application Priority Data
Oct. 30, 2006 (JP) 2006-294456
Jan. 24, 2007 (JP) 2007-014325

(51) Int. Cl. G11B 5/127

(52) U.S. Cl. 360/110

(57) ABSTRACT

The present invention provides an insulation characteristic measuring method of measuring electrical insulation of magnetic head elements formed on a wafer. Each of the magnetic head elements includes an upper magnetic pole layer, a lower magnetic pole layer, insulation layers disposed between the upper and lower magnetic pole layers, and a coil layer formed of a conductive material and disposed between the insulation layers. In at least one of the magnetic head elements, the upper and lower magnetic pole layers are electrically insulated from each other, and the upper and lower magnetic pole layers and the coil layer of the element are respectively connected to terminals of electrodes for measuring insulation. The insulation characteristic of the magnetic head elements is measured by the electrodes. It is therefore possible to measure whether insulation is ensured between layers of the magnetic head elements, which need to be insulated from each other.

### BACKGROUND OF THE INVENTION

1. Field of the Invention

The present invention relates to a method of measuring whether or not insulation is ensured between layers of a thin film magnetic head formed on a wafer, when the layers need to be insulated from each other.

2. Description of the Related Art

With the increase in capacity of a magnetic storage device, the recording density of a magnetic recording medium has been increasing each year. This advancement of the high density recording technique mainly owes to the reduction in noise of the magnetic recording medium and the improvement in sensitivity and the reduction in size of a thin film magnetic head. In particular, a hard disk device is used to record moving images in a home video apparatus, a PC (Personal Computer), and so forth, and has a large capacity for recording information. Thus, a further increase in recording density is demanded in the hard disk device.

As the thin film magnetic head, a hybrid thin film magnetic head has been widely used in which an inductive magnetic conversion element for recording information and a magnetoresistance effect element for reproducing information are laminated. In the manufacturing process of the thin film magnetic head, to measure whether or not insulation is ensured between layers of the magnetic head, which are required to form a writing section, the magnetic head element is directly measured. Therefore, there is a possibility that destruction or deterioration in characteristics of the magnetic head element is caused, depending on the measurement conditions. Further, in the case of insulation failure, the location of the insulation failure is identified by cutting the respective layers of the magnetic head element and observing the cross sections of the layers. However, it is difficult to identify the location of the failure, and the analysis process takes time.

Conventional art documents relating to the technique of measuring the insulation in the manufacturing process of the magnetic head element include Japanese Unexamined Patent Application Publication Nos. 06-084146 and 11-306519.

### SUMMARY OF THE INVENTION

One aspect is a wafer having a plurality of magnetic head elements and at least magnetic head monitor element. The magnetic head element having an upper magnetic layer, a lower magnetic layer, an insulating layer located between the upper magnetic layer and the lower magnetic layer, and a coil layer composed of a conductive material, formed in the insulating layer. The magnetic head monitor element having an upper magnetic layer, a lower magnetic layer, an insulating layer located between the upper magnetic layer and the lower magnetic layer, a coil layer composed of a conductive material, formed in the insulating layer, and the upper magnetic layer of said monitor element being separated by the insulating layer from the lower magnetic layer upper coil layer and the lower coil layer of each of the magnetic head elements may be measured by the electrodes connected to the upper coil layer and the lower coil layer of the at least one of the magnetic head elements.

Accordingly, the insulation between the respective layers forming each of the magnetic head elements can be checked without destroying the element.

### BRIEF DESCRIPTION OF THE DRAWINGS

FIG. 1 is a diagram illustrating an arrangement of magnetic head elements and insulation monitoring elements on a wafer in the first embodiment;

FIG. 2 is an enlarged view of a surface of the wafer illustrated in FIG. 1;

FIG. 3 is an enlarged view of the magnetic head element on the wafer in the first embodiment;

FIG. 4 is an enlarged view of the insulation monitoring element on the wafer in the first embodiment;

FIG. 5 is a cross-sectional view of the magnetic head element in the first embodiment;

FIG. 6 is a cross-sectional view of the insulation monitoring element in the first embodiment;

FIG. 7 is the first diagram illustrating a manufacturing process of the magnetic head element in the first embodiment;

FIG. 8 is the second diagram illustrating the manufacturing process of the magnetic head element in the first embodiment;

FIG. 9 is the third diagram illustrating the manufacturing process of the magnetic head element in the first embodiment;

FIG. 10 is the fourth diagram illustrating the manufacturing process of the magnetic head element in the first embodiment;

FIG. 11 is the fifth diagram illustrating the manufacturing process of the magnetic head element in the first embodiment;

FIG. 12 is the sixth diagram illustrating the manufacturing process of the magnetic head element in the first embodiment;

FIG. 13 is the seventh diagram illustrating the manufacturing process of the magnetic head element in the first embodiment;

FIG. 14 is the eighth diagram illustrating the manufacturing process of the magnetic head element in the first embodiment;

FIG. 15 is the first diagram illustrating a manufacturing process of the insulation monitoring element in the first embodiment;

FIG. 16 is the second diagram illustrating the manufacturing process of the insulation monitoring element in the first embodiment;

FIG. 17 is the third diagram illustrating,the manufacturing process of the insulation monitoring element in the first embodiment;

FIG. 18 is the fourth diagram illustrating the manufacturing process of the insulation monitoring element in the first embodiment;

FIG. 19 is the fifth diagram illustrating the manufacturing process of the insulation monitoring element in the first embodiment;

FIG. 20 is the sixth diagram illustrating the manufacturing process of the insulation monitoring element in the first embodiment;

FIG. 21 is the seventh diagram illustrating the manufacturing process of the insulation monitoring element in the first embodiment;

FIG. 22 is the eighth diagram illustrating the manufacturing process of the insulation monitoring element in the first embodiment;

FIG. 23 illustrates a configuration during a measurement of the insulation monitoring element in the first embodiment;

FIG. 24 is a diagram illustrating an arrangement of magnetic head elements and insulation monitoring elements on a wafer in the second embodiment;

FIG. 25 is an enlarged view of a surface of the wafer illustrated in FIG. 24;

FIG. 26 is an enlarged view of the magnetic head element on the wafer in the second embodiment;

FIG. 27 is an enlarged view of the insulation monitoring element on the wafer in the second embodiment;

FIG. 28 is a cross-sectional view of the magnetic head element in the second embodiment;

FIG. 29 is a cross-sectional view of the insulation monitoring element in the second embodiment;

FIG. 30 illustrates a configuration during a measurement of the insulation monitoring element in the second embodiment;

FIG. 31 is an enlarged view of the configuration during the measurement of the insulation monitoring element in the first embodiment; and

FIG. 32 is an enlarged view of the configuration during the measurement of the insulation monitoring element in the second embodiment.

### DESCRIPTION OF THE PREFERRED EMBODIMENTS

Embodiments of the present invention will be described below with reference to the drawings.

### First Embodiment

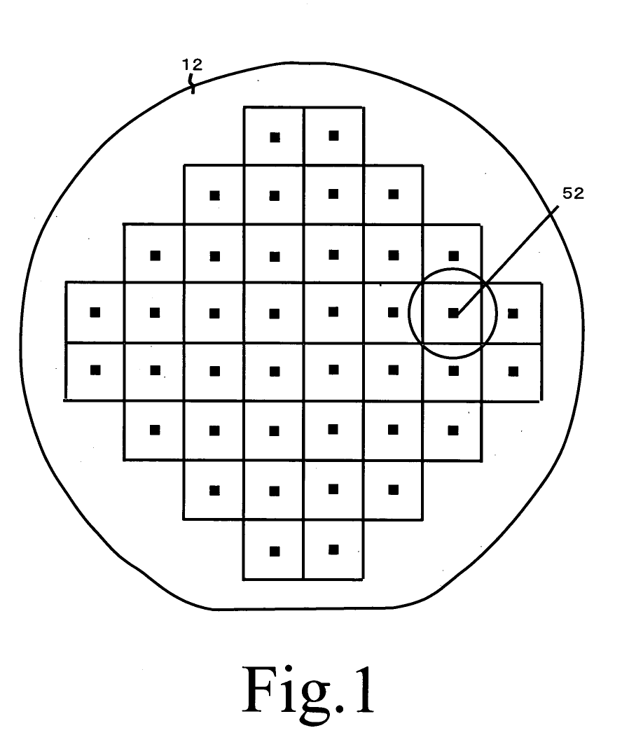

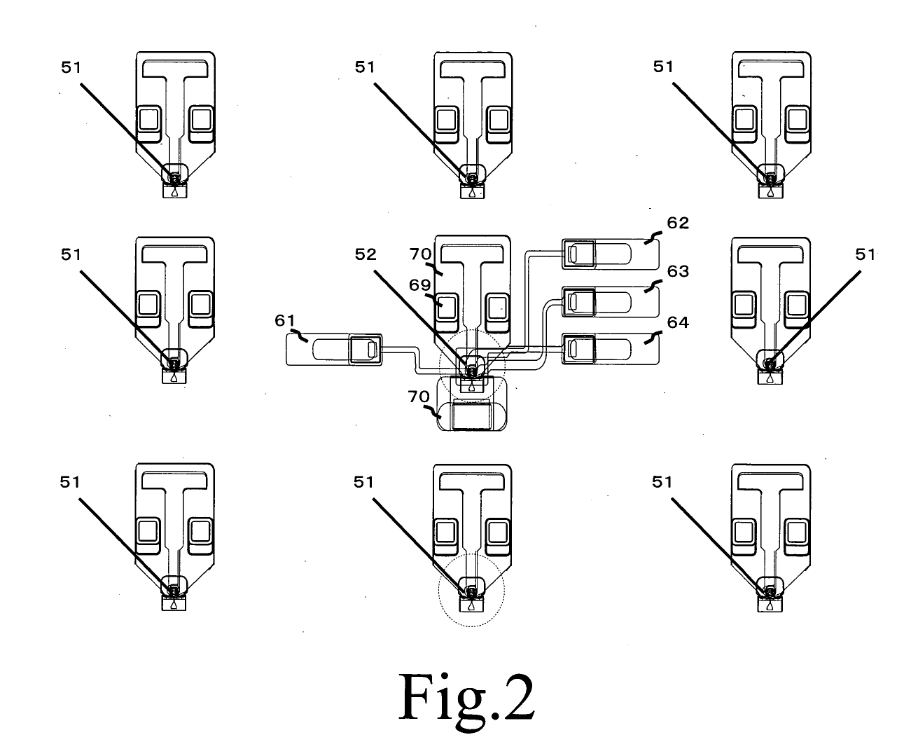

FIG. 1 is a plan view of a wafer formed with insulation monitoring elements in an embodiment of the present invention. FIG. 1 illustrates the entirety of the wafer. Meanwhile, FIG. 2 is a diagram illustrating the circled portion of FIG. 1 on an enlarged scale. As illustrated in the two figures, magnetic head elements 51 are uniformly disposed on the wafer 12, and insulation monitoring elements 52 are disposed with regularity.

An insulation monitoring element is an element for measuring whether or not insulation is ensured between layers of a magnetic head element, which need to be insulated from each other. The measurement is performed by completely insulating the layers of the insulation monitoring element corresponding to the layers of the magnetic head element which need to be insulated from each other, and then measuring whether or not insulation is ensured between the layers of the insulation monitoring element. To measure whether or not the insulation is ensured, measurement pads 61, 62, 63, 64, and 70 are drawn from the respective layers of the insulation monitoring element.

In the present embodiment, the insulation monitoring elements 52 are disposed in a dispersed manner within a group of the magnetic head elements 51 on the wafer 12. For example, at least ten thousand magnetic head elements, each of which is approximately 1 mm square in size, are orderly disposed in a matrix in the horizontal and vertical directions on a wafer having a diameter Φ of 12.7 centimeters (i.e., 5 inches). That is, approximately five hundred magnetic head elements are disposed in each of the sections defined by forty squares illustrated in FIG. 1. Further, in each of the sections, the magnetic head elements 51 and the insulation monitoring elements 52 are disposed in a matrix of sixteen rows and thirty-two columns, for example. In the present embodiment, one insulation monitoring element 52 is provided with respect to the magnetic head elements 51 disposed around the insulation monitoring element 52 in the horizontal and vertical directions. That is, as illustrated in the enlarged view of FIG. 2, one insulation monitoring element 52 is disposed in a matrix, surrounded by eight magnetic head elements 51. This disposition pattern illustrated in the figure is repeated in the horizontal and vertical directions in the respective rows and columns on a plane surface of the wafer 12 illustrated in FIG. 1.

In a common manufacturing process of the magnetic head elements, the magnetic head elements are cut out into the rectangular sections shown on the wafer 12 in FIG. 1. The thus cut out sections are further cut out into pieces in the lateral direction of a group of the magnetic head elements 51 illustrated in FIG. 2, i.e., in the row direction such that leading end portions of the magnetic head elements are exposed to a lateral side of each of the pieces. The thus cut out pieces are called raw bars and subjected to processing into individual magnetic head elements and to analysis. In the above case of the matrix formed by the sections each including sixteen rows and thirty-two columns, the number of the produced raw bars corresponds to the number of the rows forming the matrix, i.e., sixteen. In each of the raw bars, thirty-two elements are aligned. The leading end portion of the magnetic head element faces a surface of a magnetic disk, and applies a magnetic field to the, magnetic disk or detects a leakage flux from the disk to enable reading or writing of magnetic records. Thereafter, the raw bar is subjected to polishing. That is, the polishing is performed at the same time on the leading end portions of the thirty-two magnetic head elements included in the single row. Then, the magnetic head elements are subjected to a characteristic measurement. Alternatively, the raw bar may be cut into individual magnetic head elements and thereafter subjected to the characteristic measurement. Thereby, the magnetic head elements are completed.

In the present embodiment, the group of the magnetic head elements forming a single row, i.e., a single raw bar includes fifteen to sixteen insulation monitoring elements. Needless to say, the disposition pattern of the magnetic head elements 51 and the insulation monitoring elements 52 is not limited to the pattern illustrated in the figure. If the insulation monitoring element is simply disposed at each of four corners of the wafer, however, there are some cases in which the measurement performed by the insulation monitoring elements does not correspond to the measurement of the magnetic head elements formed in a central area of the wafer due to the difference in thickness between the central area of the wafer on the obtained layer and the portions of the layer formed as the insulation monitoring elements. The difference is caused by a variation in performance of a manufacturing apparatus, such as sputtering performance. Thus, caution should be exercised in the disposition of the insulation monitoring elements.

In a trial manufacturing process, it is preferable to uniformly measure the characteristic by alternately disposing the insulation monitoring element as illustrated in FIG. 2. Meanwhile, if the stabilization of the layer formation has been confirmed, the insulation monitoring element 52 may be disposed, for example, at three positions in total, i.e., at each of the opposite sides and the center of the head group of the thirty-two magnetic head elements cut out into a row as described above, or at each of the opposite sides of the group. Alternatively, the insulation monitoring element 52 may be disposed at the center of the head group, i.e., the thirty-two magnetic head elements subjected to the polishing at the same time. Accordingly, it is possible to substantially increase the total number of the magnetic head elements manufactured from one wafer, while simplifying and assuring the characteristic measurement.

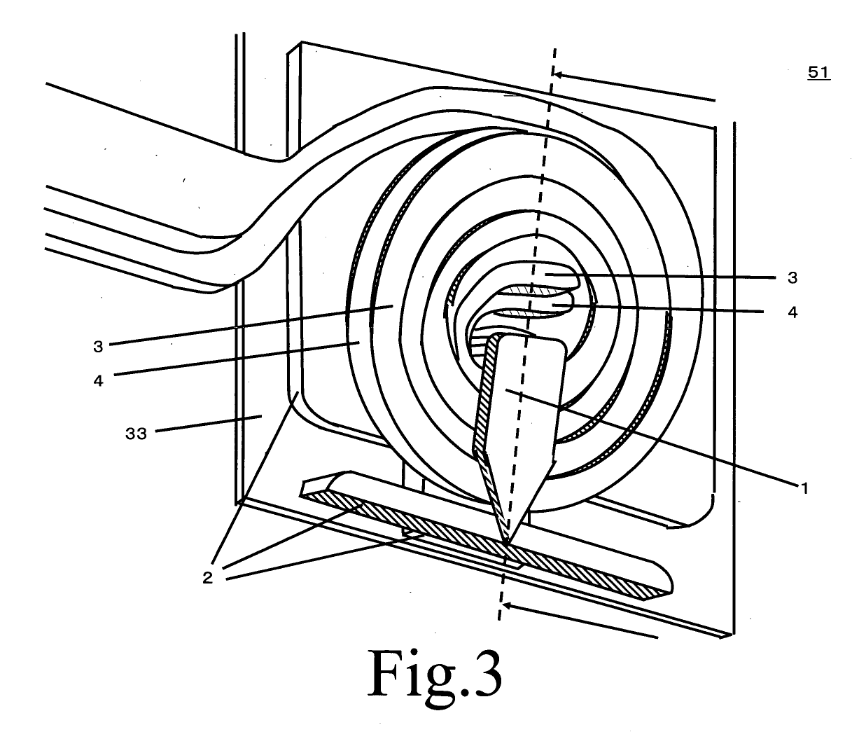

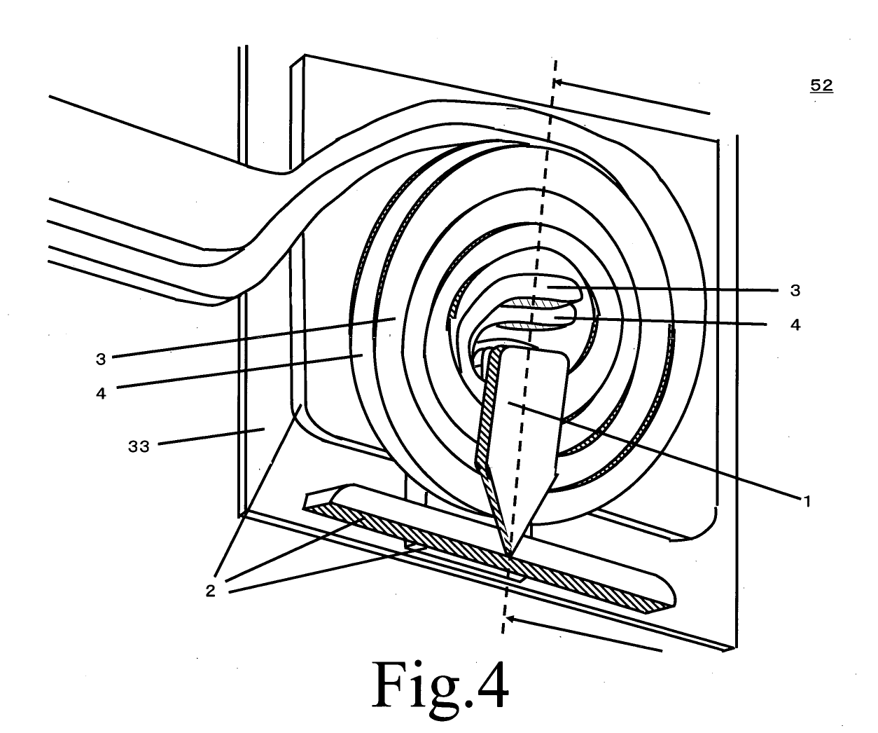

FIG. 3 is a diagram illustrating the circled magnetic head element 51 of FIG. 2 on an enlarged scale, showing a perspective of a part of the layers of the element. FIG. 4 is a diagram illustrating the circled insulation monitoring element 52 of FIG. 2 on an enlarged scale, showing a perspective of a part of the layers of the element. In FIGS. 3 and 4, insulation layers are omitted.

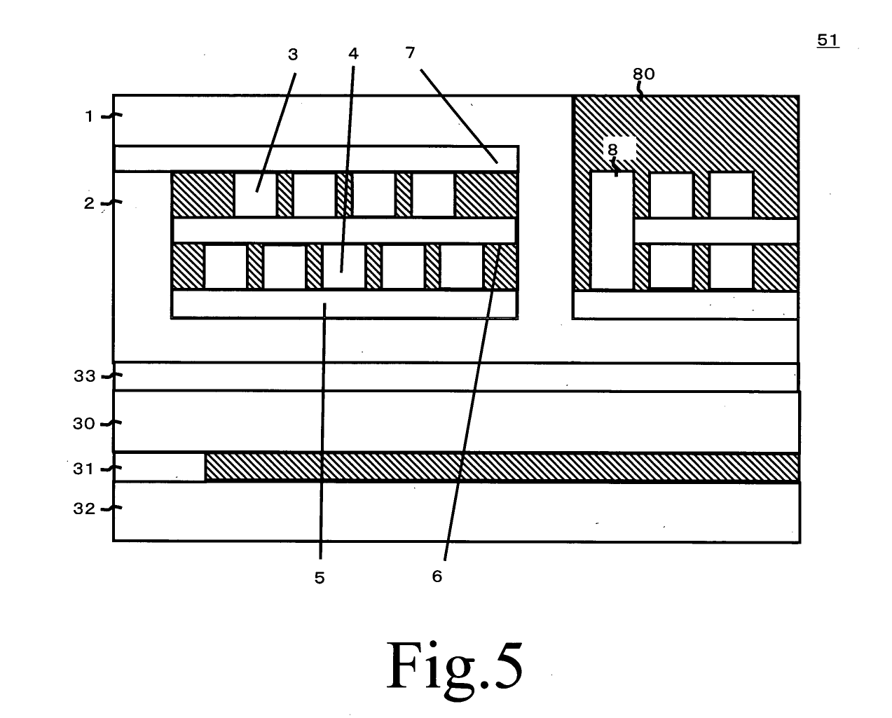

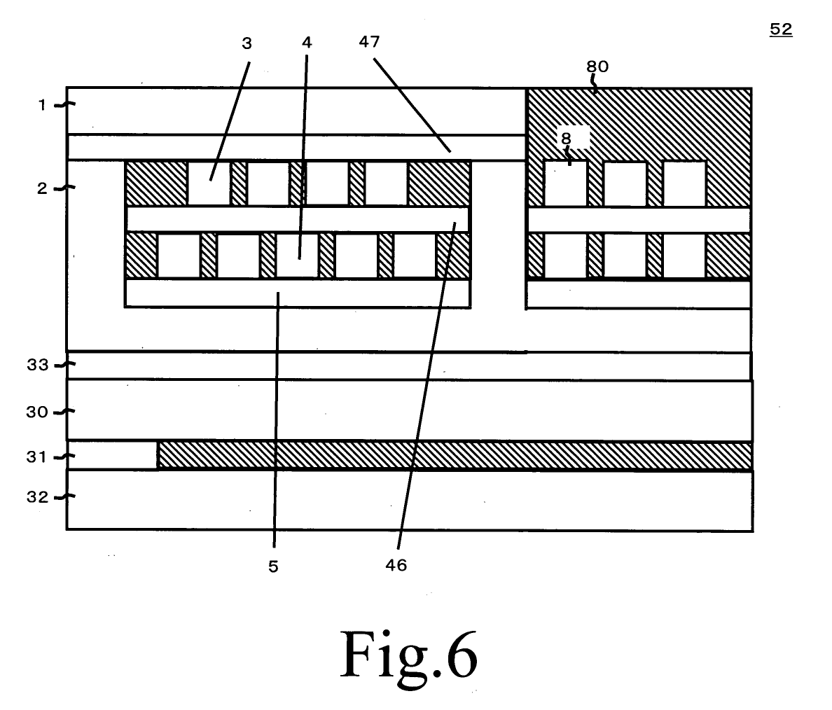

FIG. 5 is a cross-sectional view of the position in the magnetic head element 51 indicated by the dashed line in FIG. 3, as viewed in the direction of the arrows. The figure is the cross-sectional view of the range sandwiched by the arrows in the figure, as viewed in the direction of the arrows. FIG. 6 is a cross-sectional view of the position in the insulation monitoring element 52 indicated by the dashed line in FIG. 4, as viewed in the direction of the arrows. In FIGS. 3 to 6, the same members are assigned with the same reference numerals. The magnetic head element 51 and the insulation monitoring element 52 are formed on the same wafer 12. The manufacturing processes of the magnetic head element 51 and the insulation monitoring element 52 will be later described.

In FIG. 5, the magnetic head element 51 mainly includes a reading section and a writing section. The reading section includes a magnetoresistance effect (MR) element 31, which receives a magnetic field from a magnetic recording medium to generate a regenerative signal in accordance with the magnetic field, and an upper shielding layer 30 and a lower shielding layer 32, which are disposed to sandwich the magnetoresistance effect element 31 from the opposite sides in the direction of the film thickness of the element. FIG. 3 illustrates a nonmagnetic layer 33. As the MR element 31, a giant magnetoresistance effect element or a tunnel junction magnetoresistance effect (TMR) element can be used. The shielding layers 30 and 32 are formed of a magnetic material, such as NiFe, for example. Meanwhile, the writing section includes a lower magnetic pole layer 2, an upper coil layer 3, a lower coil layer 4, and an upper magnetic pole layer 1. Further, insulation layers 5, 6, and 7 are formed around the coil layers 3 and 4, and the upper magnetic pole layer 1 formed of a soft magnetic material is formed on the insulation layer 7. That is, the upper coil layer 3 and the lower coil layer 4 are sandwiched between the upper magnetic pole layer 1 and the lower magnetic pole layer 2. The nonmagnetic layer 33 having a uniform thickness is sandwiched between the lower magnetic pole layer 2 of the writing section and the upper shielding layer 30 of the reading section. The nonmagnetic layer 33 magnetically separates the lower magnetic pole layer 2 from the upper shielding layer 30. The nonmagnetic layer 33 is formed of Al₂O₃, for example. The upper magnetic pole layer 1 and the lower magnetic pole layer 2 form a magnetic circuit which surrounds the upper coil layer 3 and the lower coil layer 4. When the upper coil layer 3 and the lower coil layer 4 are applied with a current, a magnetic flux flow is generated. Then, the magnetic flux flow moves between the lower magnetic pole layer 2 and the upper magnetic pole layer 1 while circumventing the nonmagnetic layer 33, and leaps outside to change the magnetization direction of the magnetic recording medium. Thereby, information is written.

The insulation monitoring element 52 is substantially similar in configuration to the magnetic head element 51. Thus, the same members are assigned with the same reference numerals. The insulation monitoring element 52 is formed on the wafer 12 together with the magnetic head element 51. With the insulation monitoring element 52 formed on the same wafer 12 on which the magnetic head element 51 is formed, the insulation of the respective layers of the magnetic head element 51 can be checked. That is, in the insulation monitoring element 52 of FIG. 6, unlike the insulation layer 7 of the above-described magnetic head element 51, an insulation layer 47 completely separates the upper magnetic pole layer 1 from the lower magnetic pole layer 2. Thereby, the upper magnetic pole layer 1 and the lower magnetic pole layer 2 are insulated from each other. Further, an insulation layer 46 splits a joining portion of an upper coil layer and a lower coil layer forming a coil layer 8, which is disposed on the right side in the figure. Thereby, unlike the insulation layer 6 of the above-described magnetic head element 51, the insulation layer 46 insulates the upper coil layer 3 from the lower coil layer 4.

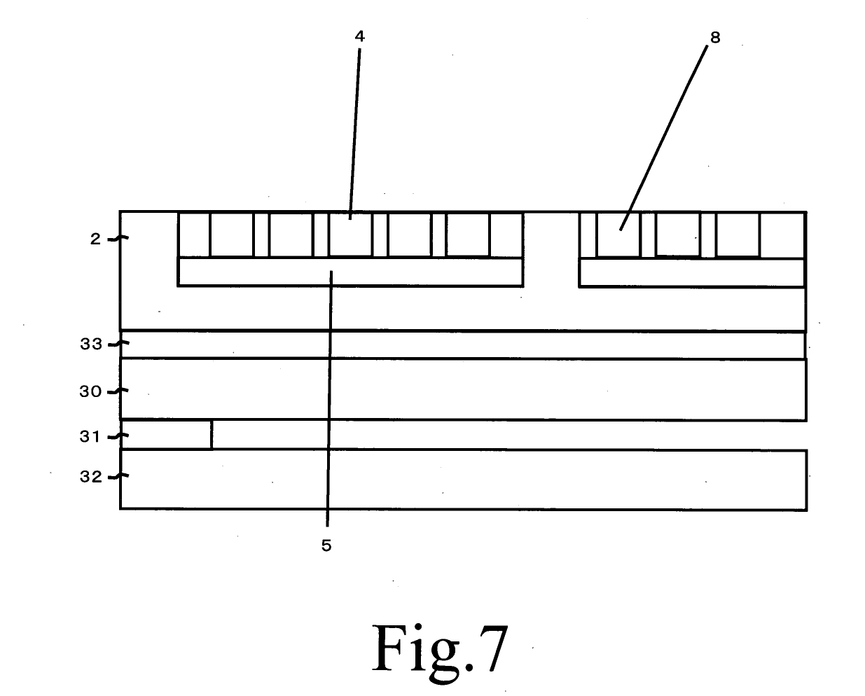

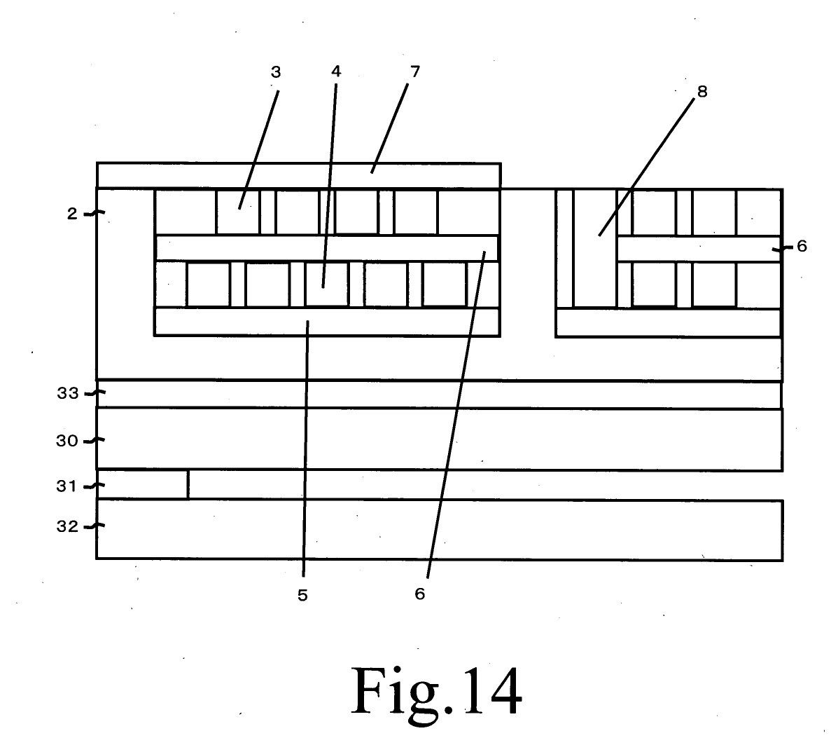

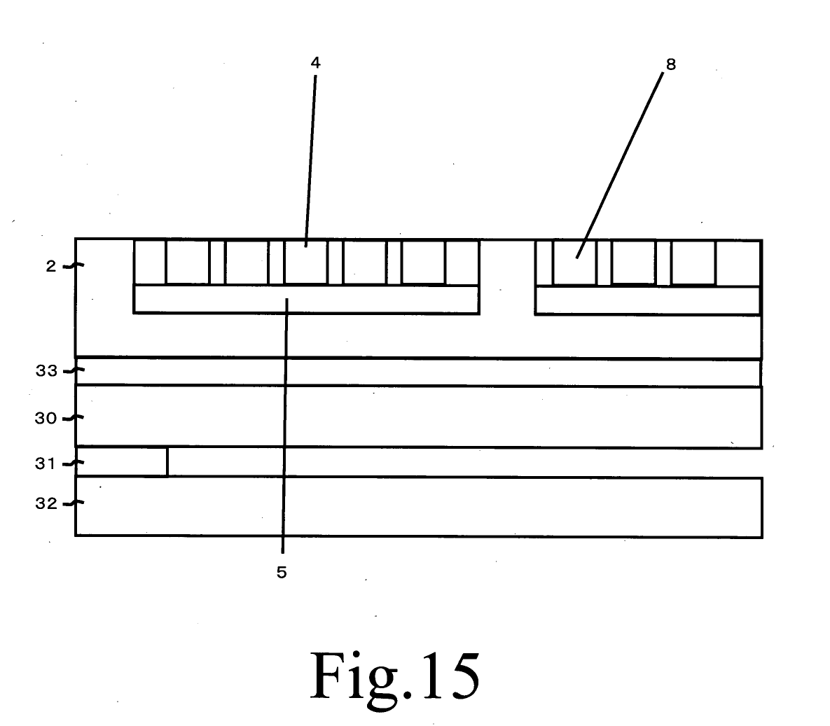

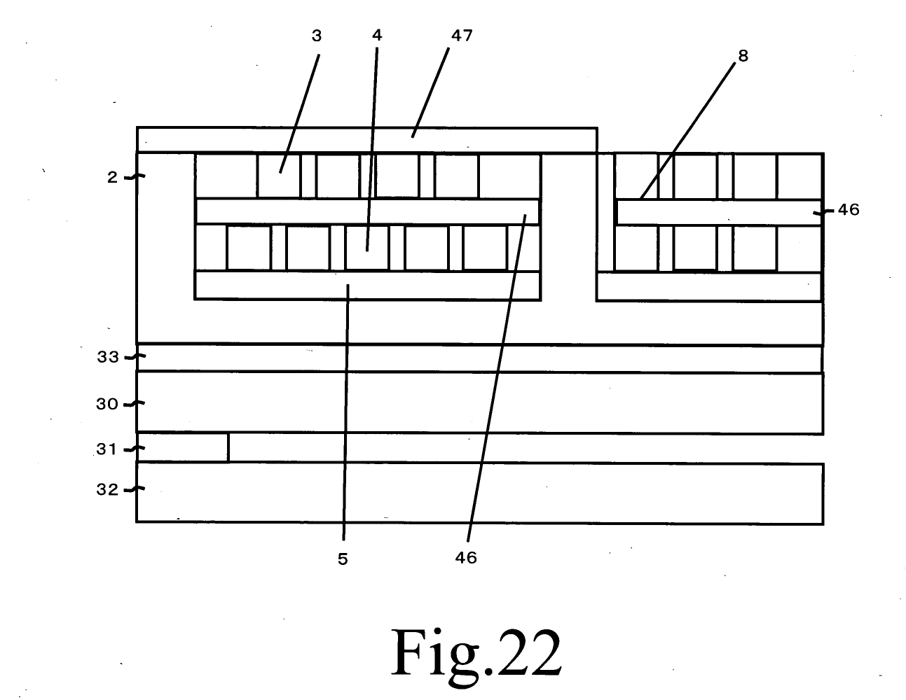

With reference to FIGS. 7 to 14, description will now be made of the manufacturing process of the magnetic head element 51 configured as described above. Similarly, with reference to FIGS. 15 to 22, description will be made of the manufacturing process of the insulation monitoring element 52 configured as described above.

In the states prior to the formation of the insulation layers 6 and 46 (FIGS. 7 and 15), the layers of the magnetic head element 51 (FIG. 7) and the layers of the insulation monitoring element 52 (FIG. 15) have both been formed on the same wafer 12 in exactly the same pattern.

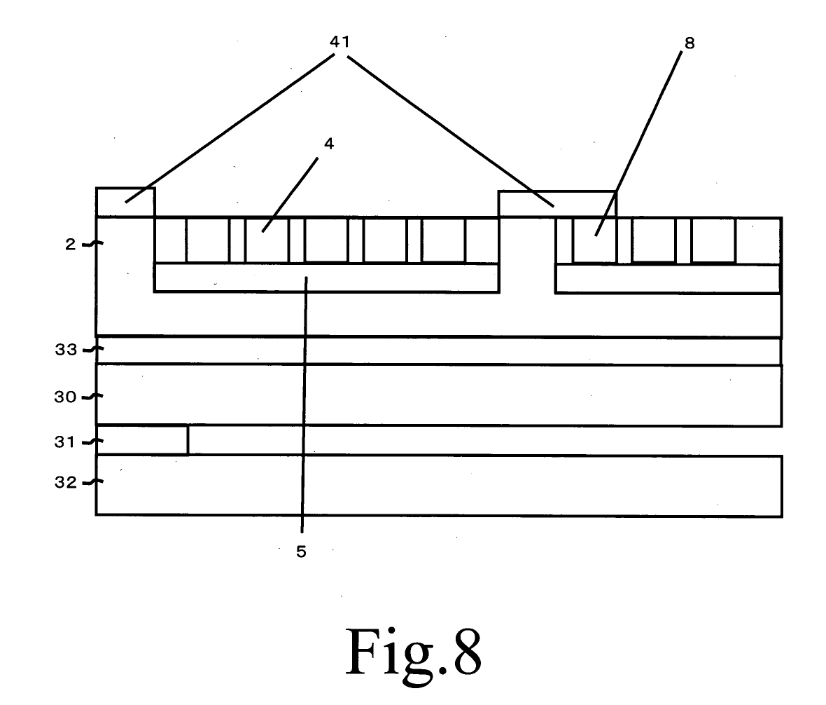

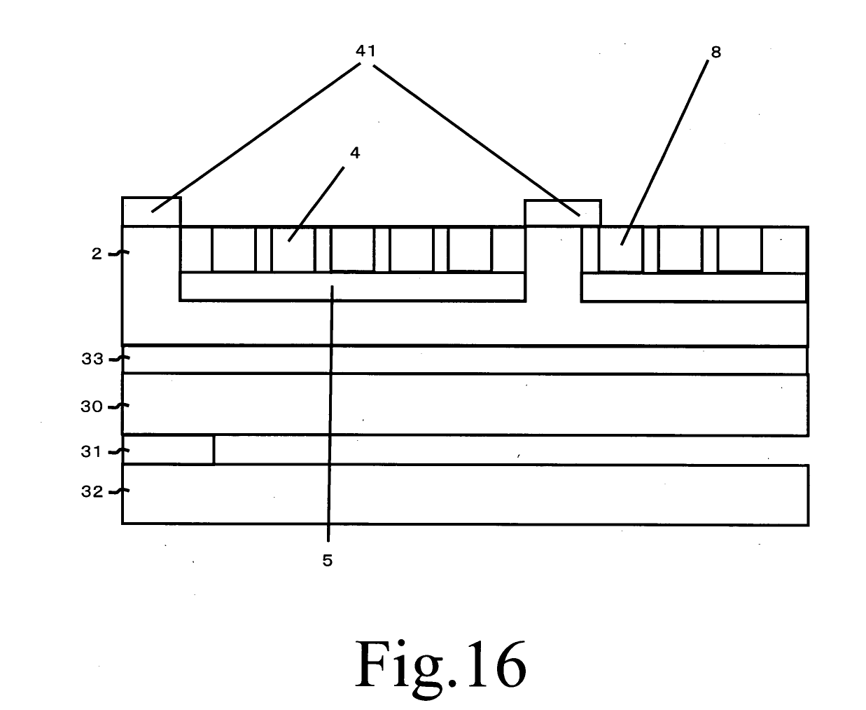

Then, a resist film 41 is formed at predetermined positions in each of the magnetic head element 51 and the insulation monitoring element 52 in a simultaneous process (FIGS. 8 and 16). In this case, as illustrated in the two figures, the two elements are different from each other in the pattern of the resist film 41. That is, the resist film 41 is formed on a part of the coil layer 8 in the magnetic head element 51 (FIG. 8), while the resist film 41 is not formed on the part of the coil layer 8 in the insulation monitoring element 52 (FIG. 16).

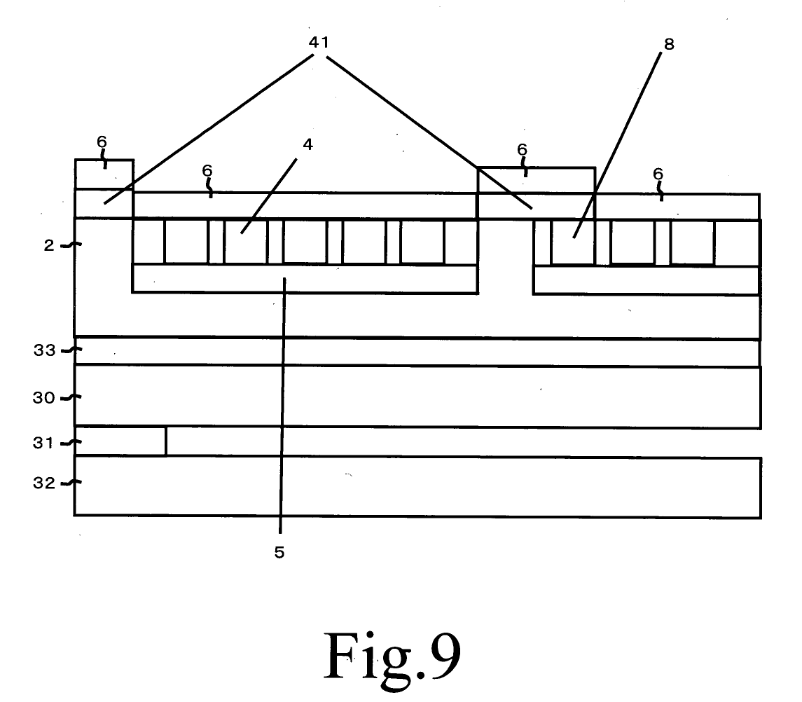

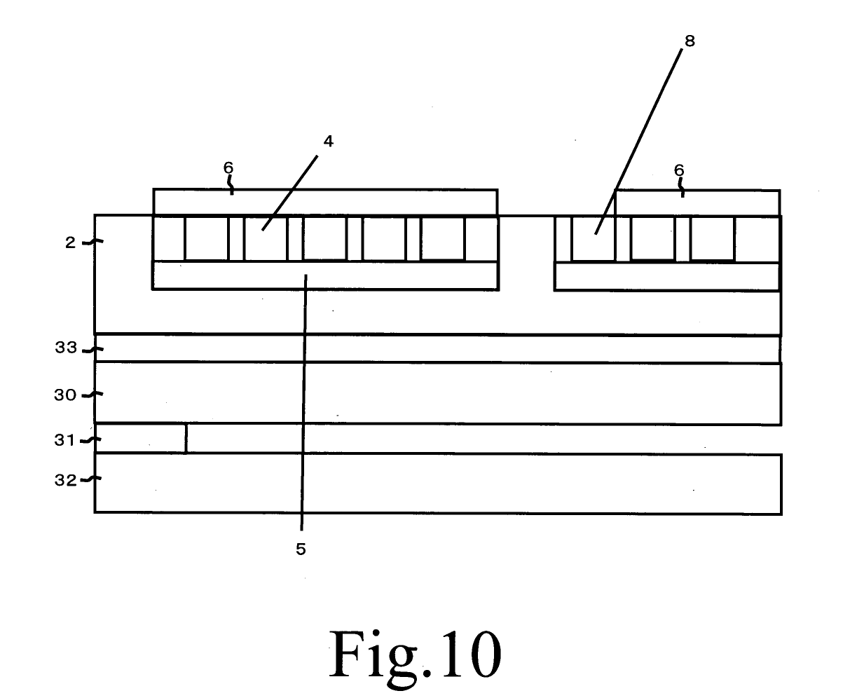

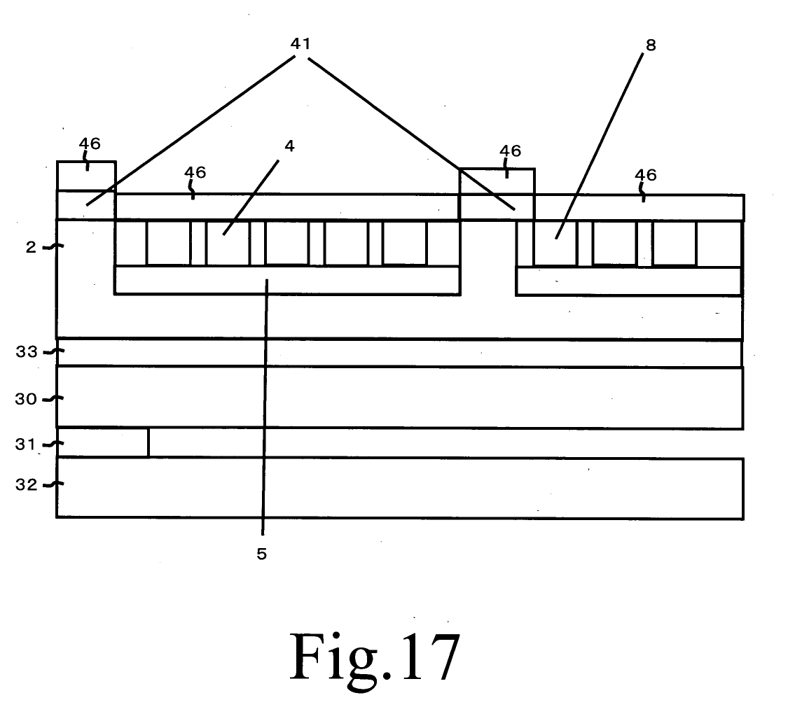

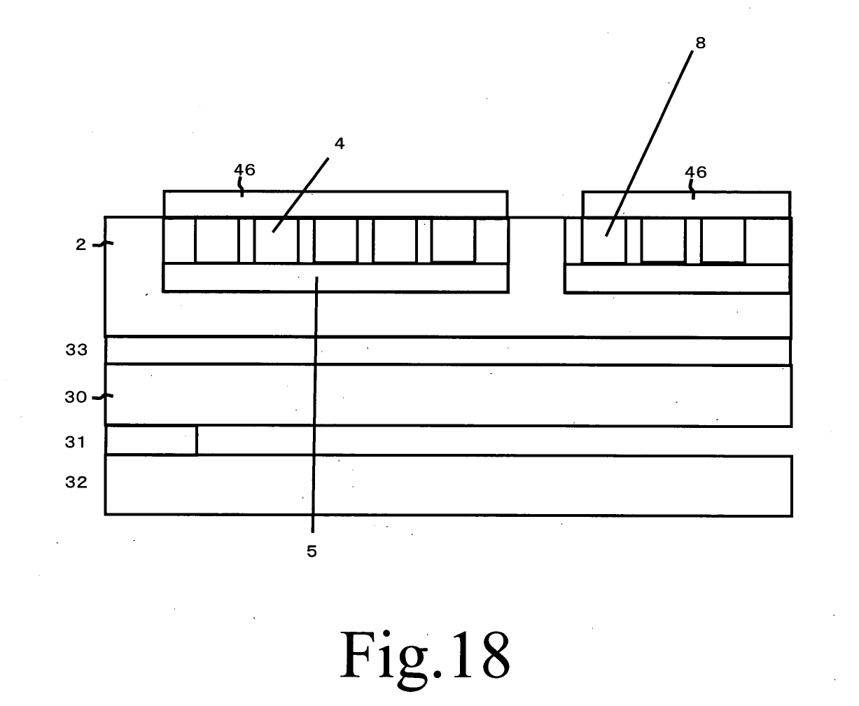

Subsequently, the insulation layers 6 and 46 are formed on the resist film 41 in the same process (FIGS. 9 and 17). Then, the resist film 41 is removed. Thereby, as illustrated in FIGS. 10 and 18, the insulation layer 6 is not formed on the conduction area of the coil layer 8 in the magnetic head element 51 illustrated in FIG. 10, while the insulation layer 46 is formed on the coil layer 8 in the insulation monitoring element 52 illustrated in FIG. 18. That is, as described with reference to FIGS. 5 and 6, the pattern of the insulation layer 6 of the magnetic head element 51 and the pattern of the insulation layer 46 of the insulation monitoring element 52 are formed as different patterns from each other in the joining portion of the coil layer 8.

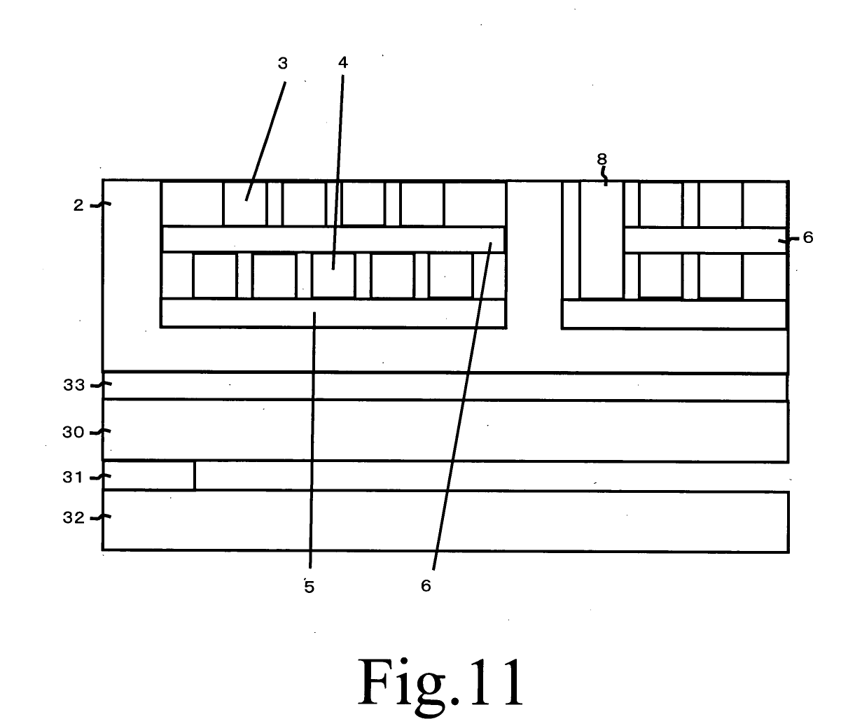

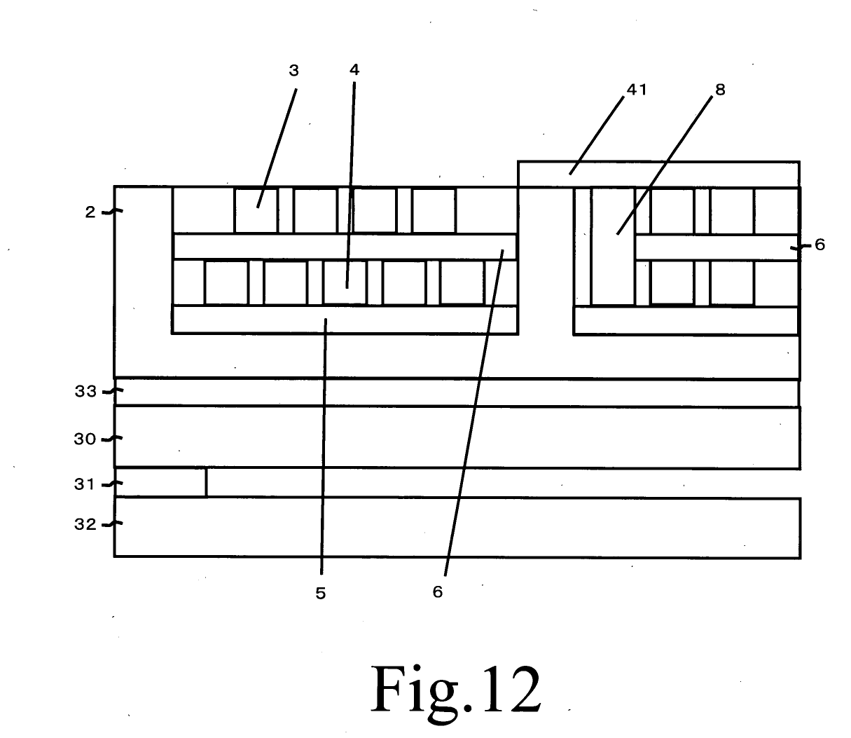

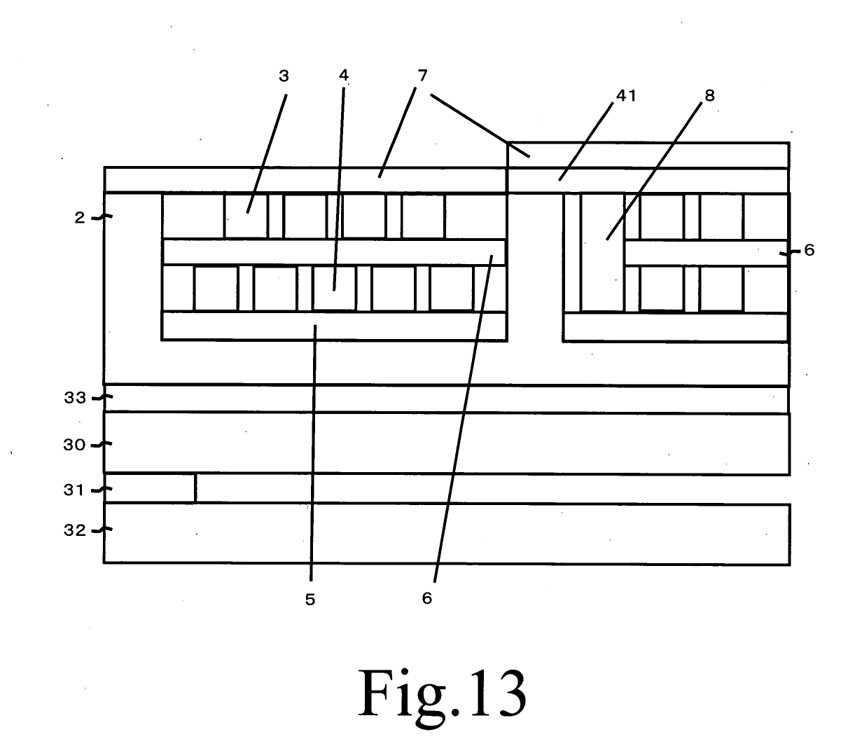

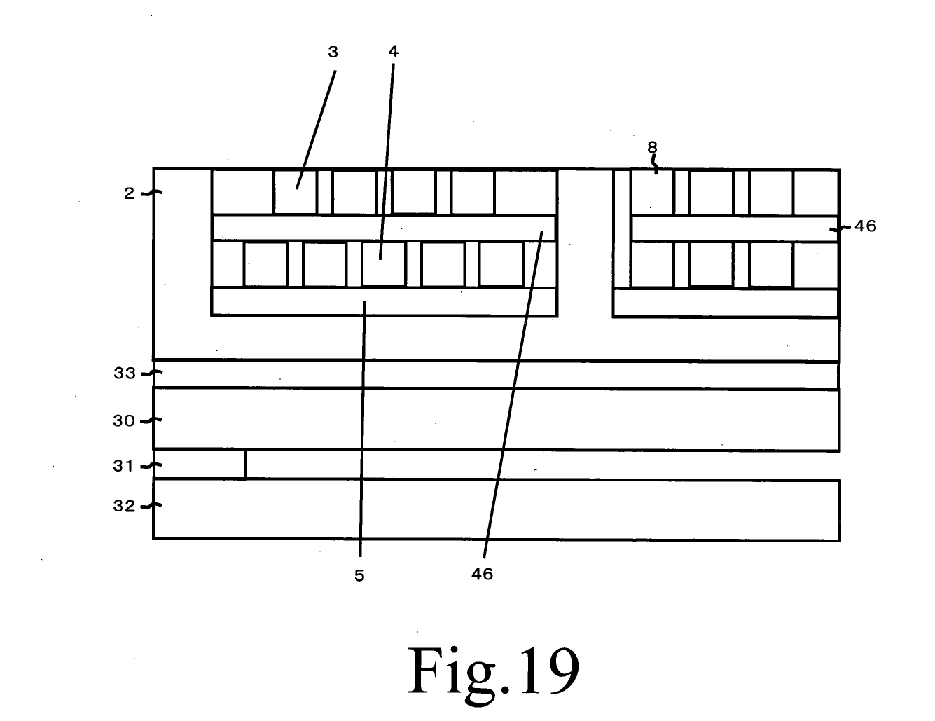

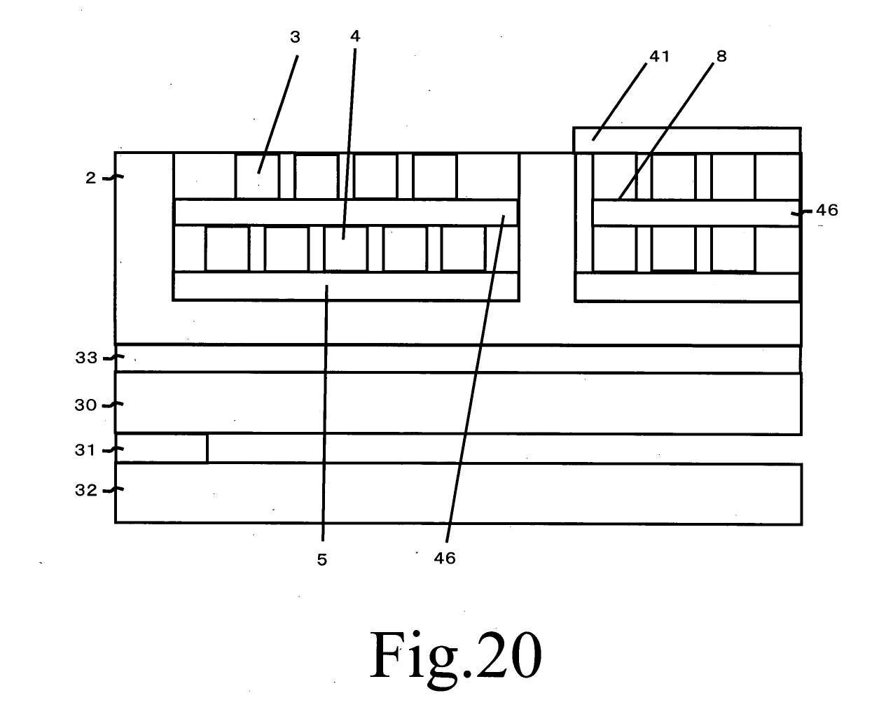

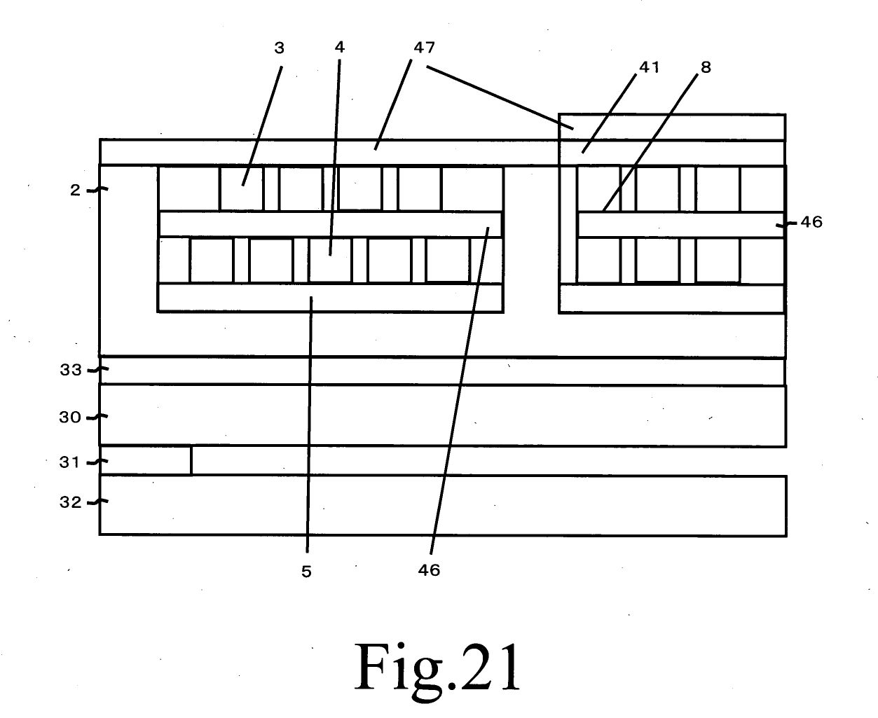

The conduction area of the coil layer 8 is thus formed, and the states prior to the formation of the insulation layers 7 and 47 are formed, as illustrated in FIGS. 11 and 19. Then, as illustrated in FIGS. 12 and 20, the resist film 41 is formed at a predetermined position. Thereafter, as illustrated in FIGS. 13 and 21, the insulation layers 7 and 47 are formed on the resist film 41. Then, the resist film 41 illustrated in FIGS. 13 and 21 is removed to form the insulation layers 7 and 47 at a predetermined position in the magnetic head element 51 and the insulation monitoring element 52, respectively. In this case, the pattern of the resist film 41 is differentiated between the magnetic head element 51 and the insulation monitoring element 52. Thereby, in the insulation monitoring element 52, the insulation layer. 47 covers the upper coil layer 3 and the lower magnetic pole layer 2 on the left side of the figure, as illustrated in FIG. 21.

The manufacturing process illustrated in FIGS. 7 to 14 and the manufacturing process illustrated in FIGS. 15 to 21 are the same manufacturing process. That is, the insulation layers 6, 7, 46, and 47, for example, are formed at the same time on the same wafer 12 from the same material. Further, as described above, as for the range in which the resist film 41 is formed, the pattern of the mask for exposing the resist is partially differentiated between the magnetic head element 51 and the insulation monitoring element 52. Thereby, the insulation monitoring element 52, in which the upper magnetic pole layer 1 is insulated from the lower magnetic pole layer 2 and the upper coil layer 3 is insulated from the lower coil layer 4, is formed at the same time as the formation of the magnetic head element 51, which substantially corresponds to the insulation monitoring element 52 in the layer structure.

Accordingly, in the corresponding structure, the corresponding layers of the magnetic head element 51 and the insulation monitoring element 52 are formed on the same wafer 12 at the same time in the formation process. It is therefore possible to practically approximate the characteristic between the magnetic head element 51 and the insulation monitoring element 52 formed on the wafer 12.

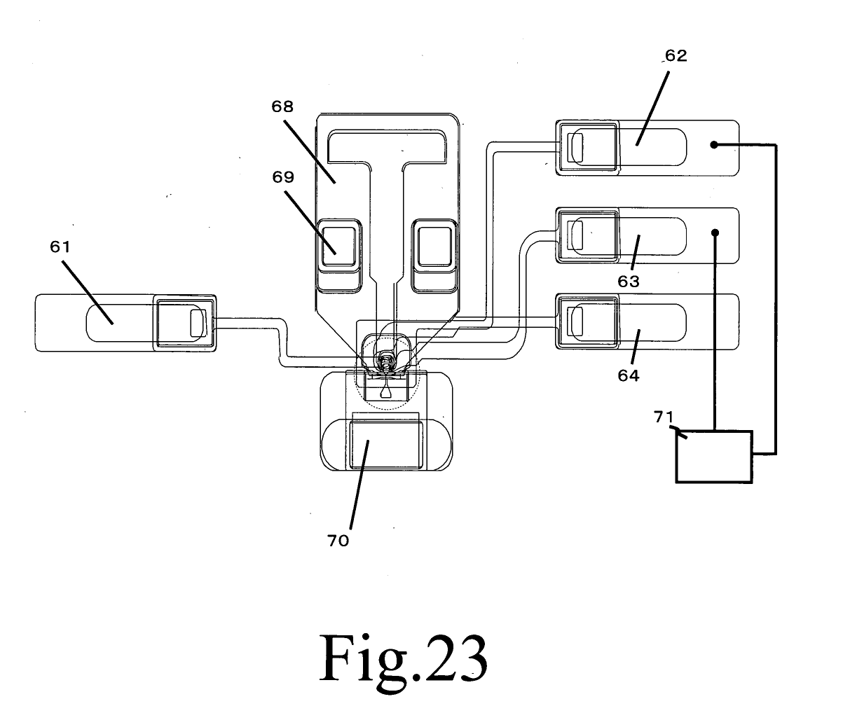

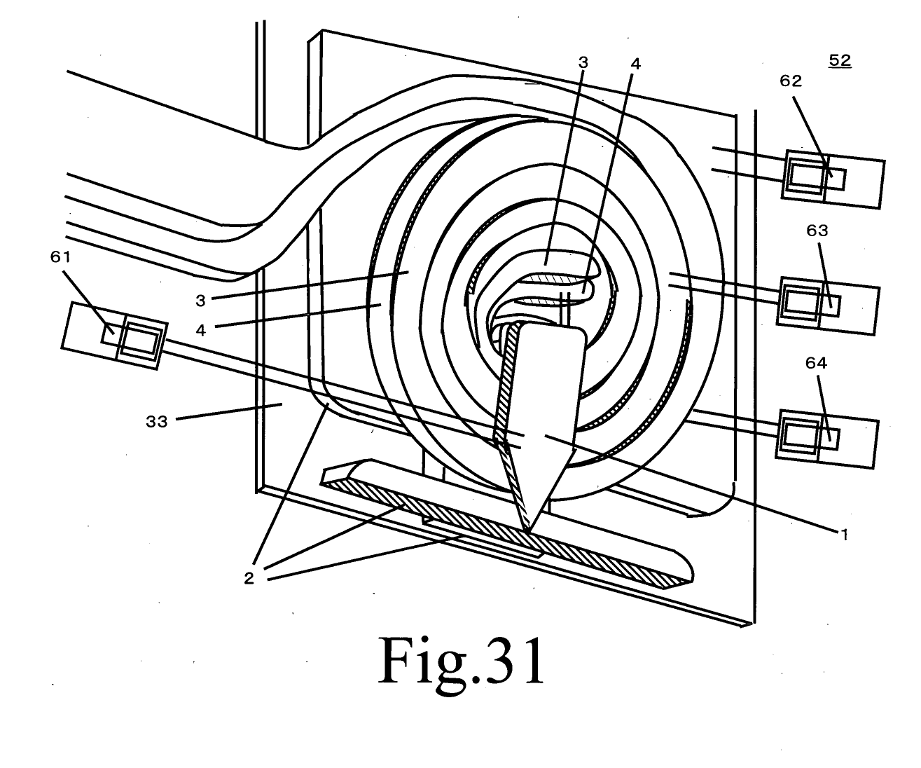

FIG. 23 illustrates a configuration during a measurement of the insulation monitoring element 52 in the first embodiment of the present invention described with reference to FIG. 2. The reference numerals 61, 62, 63, and 64 indicate the measurement pads drawn from the upper magnetic pole layer 1, the lower magnetic pole layer 2, the lower coil layer 4, and the upper coil layer 3, respectively. The reference numerals 68, 69, and 70 indicate an extraction layer from a lead element to a lead terminal, a lead terminal, and an extraction layer from the lower magnetic pole layer 2, respectively. Since the extraction layer 70 is used to measure the insulation between the coil layers and the magnetic pole layers of the magnetic head element 51, the extraction layer 70 is not used in the insulation monitoring element 52. However, the extraction layer 70 is illustrated so that the insulation monitoring element 52 takes approximately the same configuration as the configuration of the magnetic head element 51. FIG. 31 is an enlarged view of the circled portion of FIG. 23, in which the insulation layers are omitted. The respective measurement pads are drawn from the positions illustrated in FIG. 31.

As described above, the upper magnetic pole layer 1 and the lower magnetic pole layer 2 are completely insulated from each other by the insulation layer 47. Thus, the insulation between the upper magnetic pole layer 1 and the lower magnetic pole layer 2 of the magnetic head element 51 can be measured by measuring the insulation between the measurement pads 61 and 62. Thereby, it is possible to detect that the magnetic flux flow generated between the magnetic pole layers cannot be emitted outside due to a short circuit caused between the upper magnetic pole layer 1 and the lower magnetic pole layer 2 at an inappropriate position by a failure of the insulation layer 7 of the magnetic head element 51.

Further, the upper magnetic pole layer 1 and the upper coil layer 3 are completely insulated from each other by the insulation layer 47. Thus, the insulation between the upper magnetic pole layer 1 and the upper coil layer 3 of the magnetic head element 51 can be measured by measuring the insulation between the measurement pads 61 and 63. Thereby, it is possible to detect that the magnetic flux flow cannot be generated due to a short circuit caused between the upper magnetic pole layer 1 and the upper coil layer 3 by a failure of the insulation layer 7 of the magnetic head element 51.

Furthermore, the upper coil layer 3 and the lower coil layer 4 are completely insulated from each other by the insulation layer 46. Thus, the insulation between the lower coil layer 4 and the upper coil layer 3 of the magnetic head element 51 can be measured by measuring the insulation between the measurement pads 63 and 64. Thereby, it is possible to detect that the magnetic flux flow cannot be generated due to a short circuit caused between the upper coil layer 3 and the lower coil layer 4 by a failure of the insulation layer 6 of the magnetic head element 51.

In addition, the lower magnetic pole layer 2 and the lower coil layer 4 are completely insulated from each other by the insulation layer 5. Thus, the insulation between the lower magnetic pole layer 2 and the lower coil layer 4 of the magnetic head element 51 can be measured by measuring the insulation between the measurement pads 62 and 64. Thereby, it is possible to detect that the magnetic flux flow cannot be generated due to a short circuit caused between the lower magnetic pole layer 2 and the lower coil layer 4 by a failure of the insulation layer 5 of the magnetic head element 51.

FIG. 23 illustrates the state in which the measurement pads 62 and 63 are connected to a measuring device 71. With the measuring device 71 thus connected to the pads drawn from the layers, the insulation characteristic of which is to be measured, the insulation characteristic can be measured.

In this manner, the insulation characteristic of the magnetic head element can be practically measured by measuring the insulation characteristic of the insulation monitoring element. Further, even if a failure such as the insulation failure is caused, the location of the failure can be easily identified. Accordingly, the yield of the magnetic heads can be improved.

### Second Embodiment

In the first embodiment, the description has been made of the type in which the magnetic head element includes two conductive coil layers. Alternatively, the magnetic head element may include a single conductive coil layer.

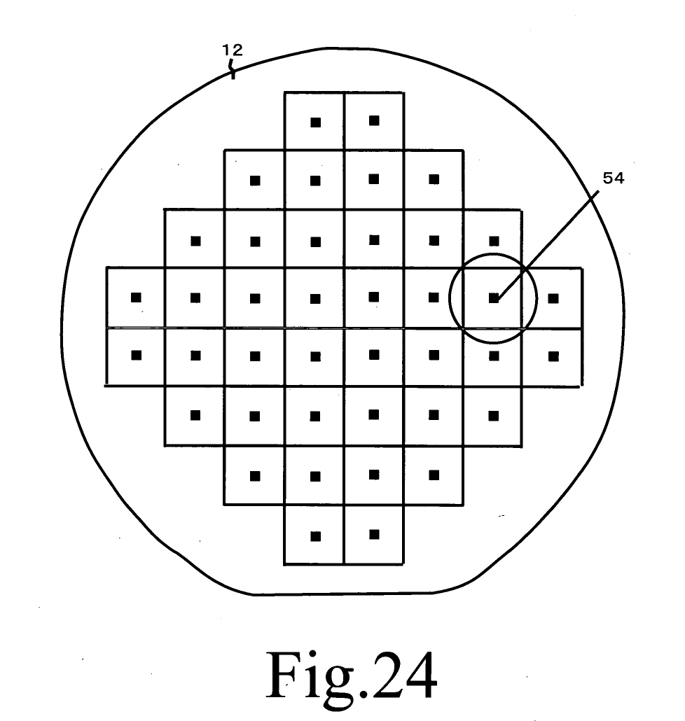

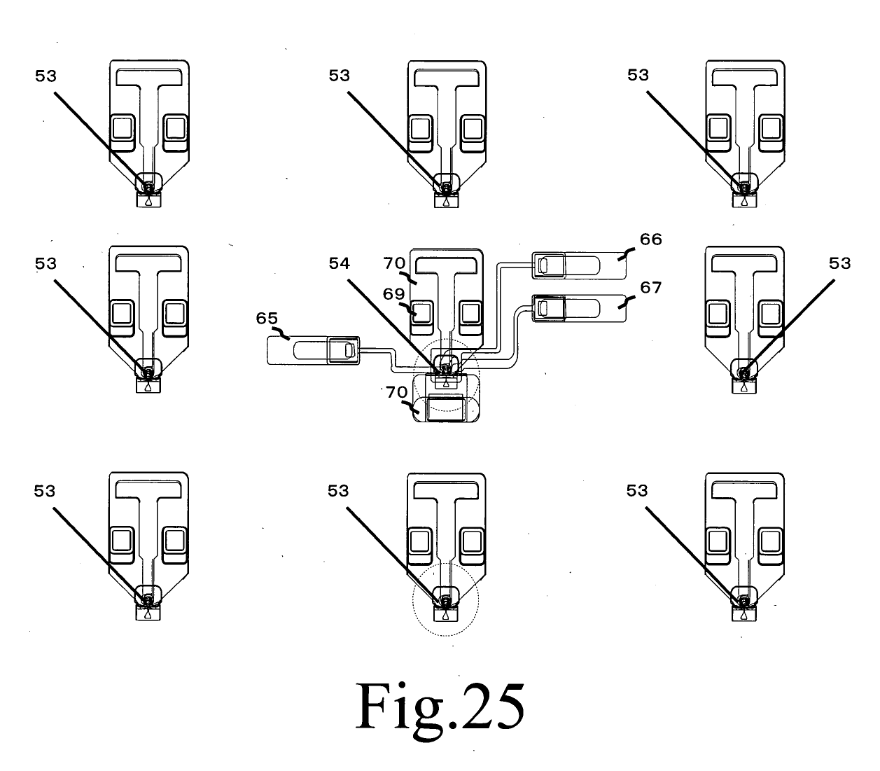

FIG. 24 is a plan view of a wafer formed with insulation monitoring elements in another embodiment of the present invention. FIG. 24 illustrates the entirety of the wafer. Meanwhile, FIG. 25 is a diagram illustrating the circled portion of FIG. 24 on an enlarged scale. As illustrated in the two figures, magnetic head elements 53 are uniformly disposed on the wafer 12, and insulation monitoring elements 54 are disposed with regularity. To measure whether or not the insulation is ensured, measurement pads 65, 66, 67, and 70 are drawn from the respective layers of each of the insulation monitoring elements 54.

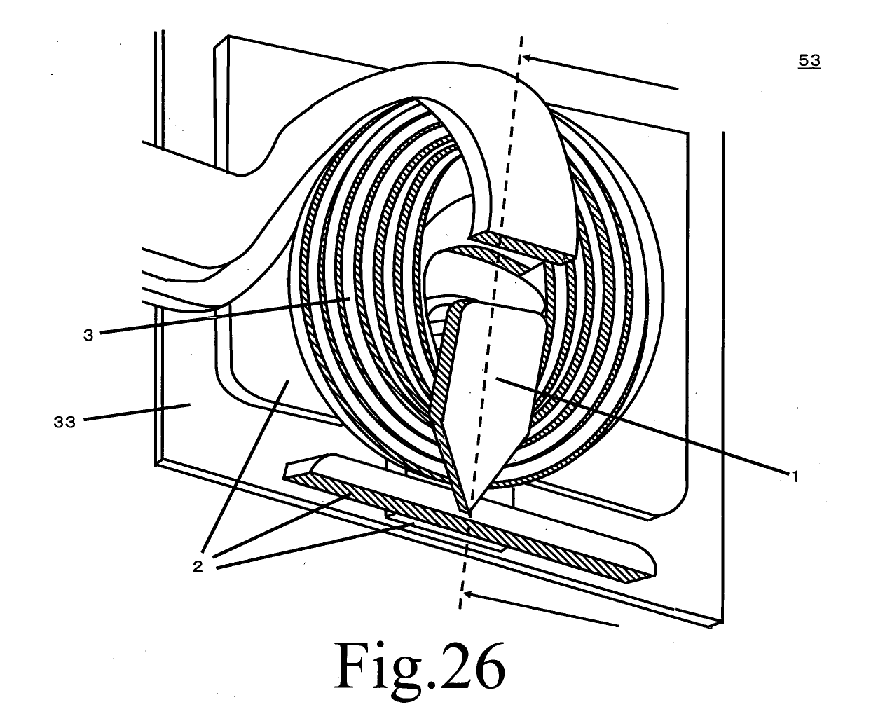

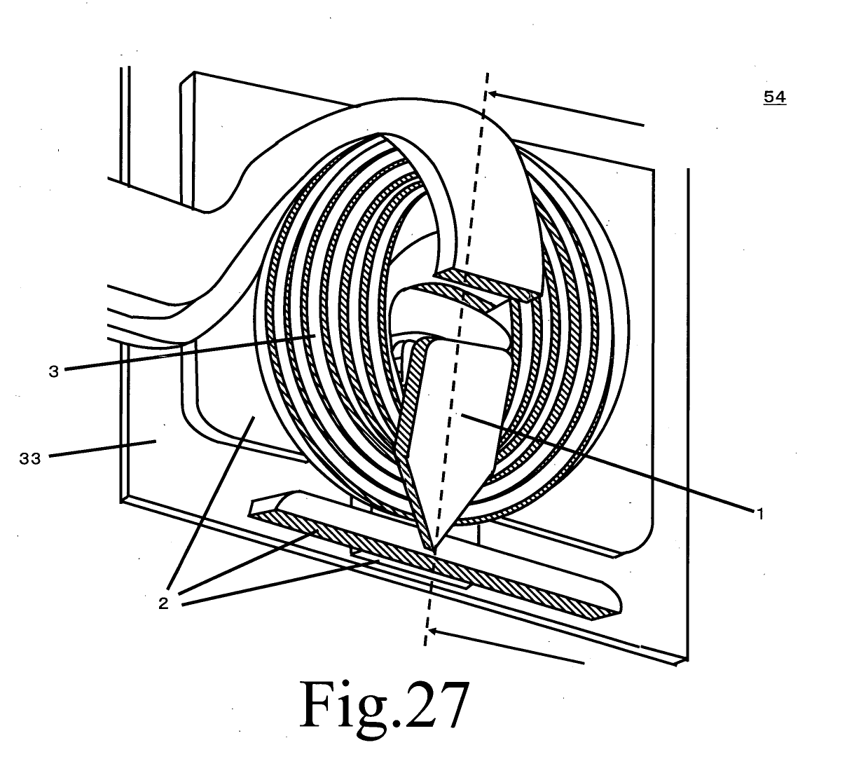

FIG. 26 is a diagram illustrating the circled magnetic head element 53 of FIG. 25 on an enlarged scale, showing a perspective view of a part of the layers of the element. FIG. 27 is a diagram illustrating the circled insulation monitoring element 54 of FIG. 25 on an enlarged scale, showing a perspective view of a part of the layers of the element. In FIGS. 26 and 27, insulation layers are omitted.

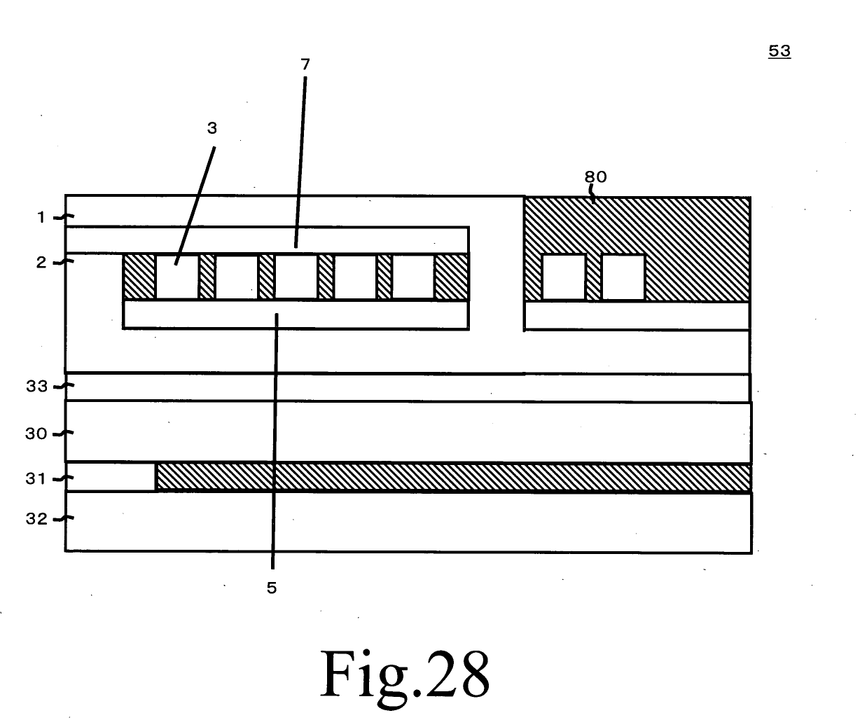

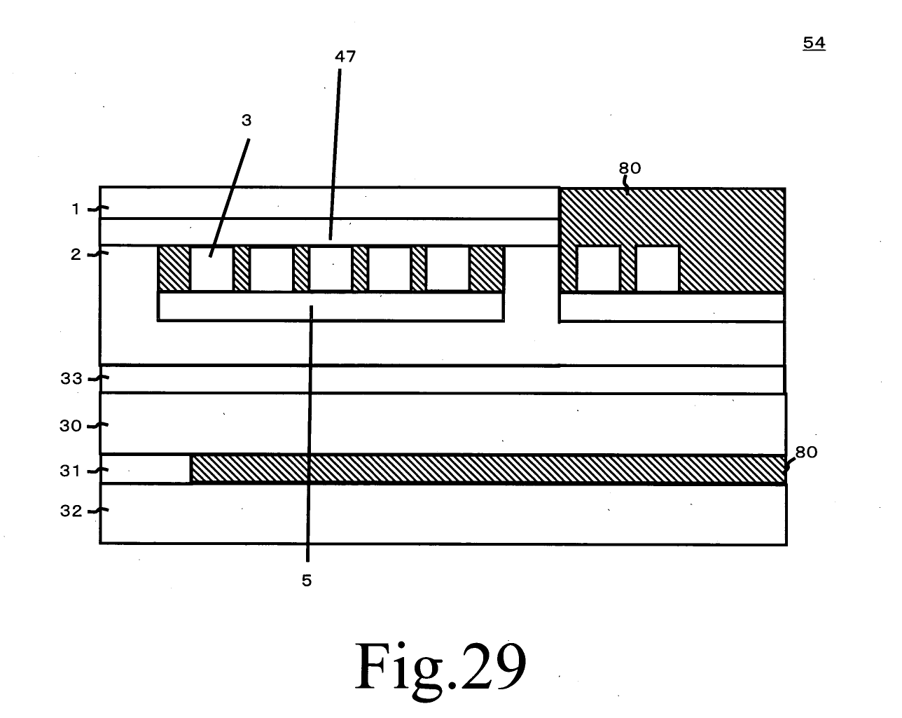

FIG. 28 is a cross-sectional view of the position in the magnetic head element 53 indicated by the dashed line in FIG. 26, as viewed in the direction of the arrows. The figure is the cross-sectional view of the range sandwiched by the arrows in the figure, as viewed in the direction of the arrows. FIG. 29 is a cross-sectional view of the position in the insulation monitoring element 54 indicated by the dashed line in FIG. 27, as viewed in the direction of the arrows. In FIGS. 27 and 29, the same members are assigned with the same reference numerals. The magnetic head element 53 of the second embodiment includes a single conductive coil layer. Except that the magnetic head element 53 includes the single conductive coil layer, the magnetic head element 53 is similar in configuration to the magnetic head element 51 of the first embodiment. Thus, the same members are assigned with the same reference numerals. The insulation monitoring element 54 is substantially similar in configuration to the magnetic head element 53. Thus, the same members are assigned with the same reference numerals. In the insulation monitoring element 54, the insulation layer 47 completely separates the upper magnetic pole layer 1 from the lower magnetic pole layer 2. Thereby, the upper magnetic pole layer 1 and the lower magnetic pole layer 2 are insulated from each other.

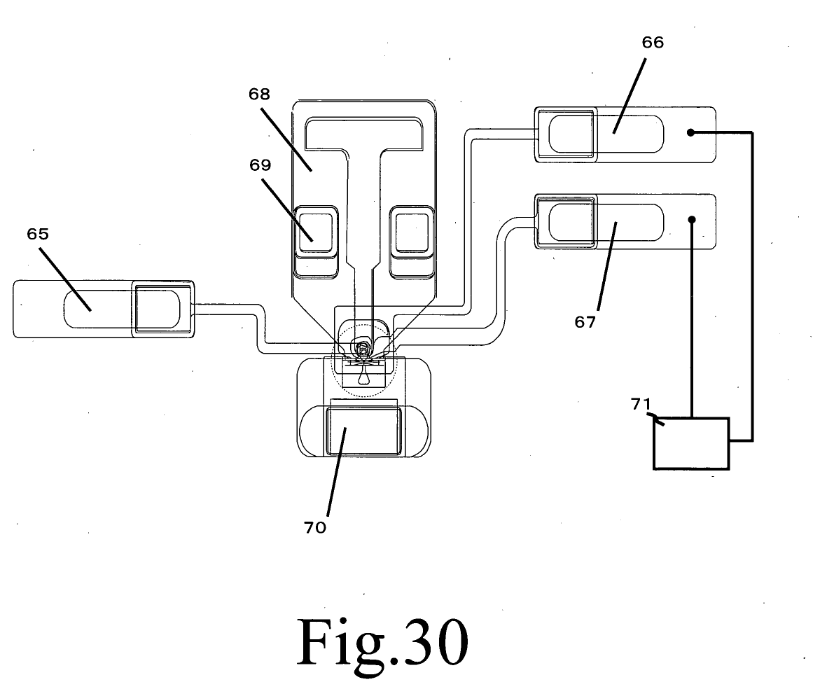

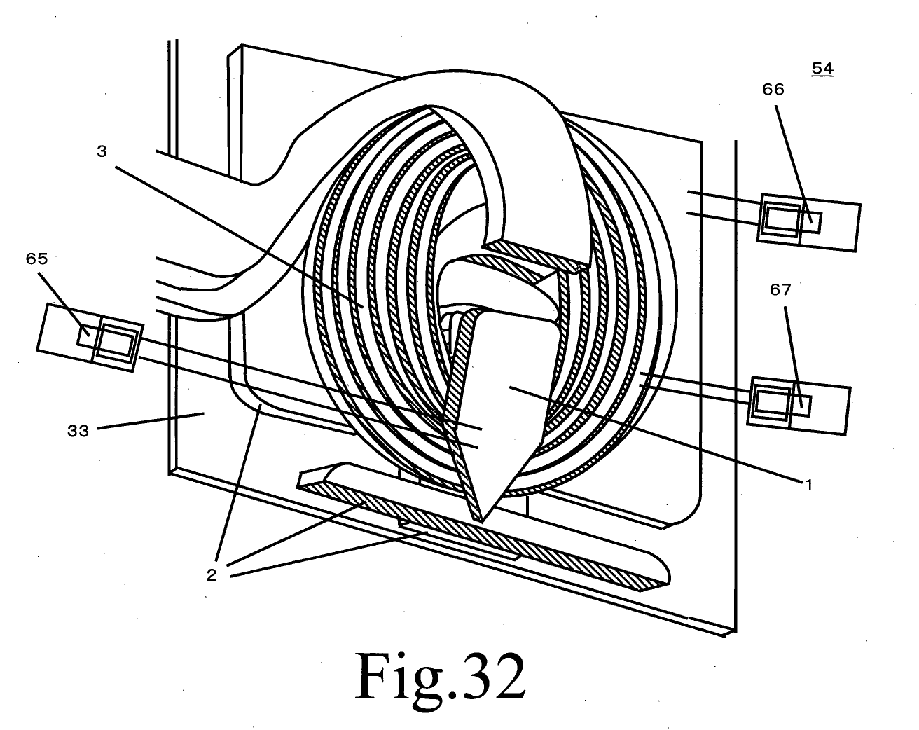

FIG. 30 illustrates a configuration during a measurement of the insulation monitoring element 54 in the second embodiment described with reference to FIG. 25. The reference numerals 65, 66, and 67 indicate the measurement pads drawn from the upper magnetic pole layer 1, the lower magnetic pole layer 2, and the coil layer 3, respectively. FIG. 32 is an enlarged view of the circled portion of FIG. 30, in which the insulation layers are omitted. The respective measurement pads are drawn from the positions illustrated in FIG. 32.

As described above, the upper magnetic pole layer 1 and the lower magnetic pole layer 2 are completely insulated from each other by the insulation layer 47. Thus, the insulation between the upper magnetic pole layer 1 and the lower magnetic pole layer 2 can be measured by measuring the insulation between the measurement pads 65 and 66. Thereby, it is possible to detect that the magnetic flux flow generated between the magnetic pole layers cannot be emitted outside due to a short circuit caused between the upper magnetic pole layer 1 and the lower magnetic pole layer 2 at an inappropriate position by a failure of the insulation layer 7 of the magnetic head element 53.

Further, the upper magnetic pole layer 1 and the coil layer 3 are completely insulated from each other by the insulation layer 47. Thus, the insulation between the upper magnetic pole layer 1 and the coil layer 3 can be measured by measuring the insulation between the measurement pads 65 and 67. Thereby, it is possible to detect that the magnetic flux flow cannot be generated due to a short circuit caused between the upper magnetic pole layer 1 and the coil layer 3 by a failure of the insulation layer 7 of the magnetic head element 53.

Furthermore, the lower magnetic pole layer 2 and the coil layer 3 are completely insulated from each other by the insulation layer 5. Thus, the insulation between the lower magnetic pole layer 2 and the coil layer 3 can be measured by measuring the insulation between the measurement pads 66 and 67. Thereby, it is possible to detect that the magnetic flux flow cannot be generated due to a short circuit caused between the coil layer 3 and the lower magnetic pole layer 2 by a failure of the insulation layer 5 of the magnetic head element 53.

FIG. 30 illustrates the state in which the measurement pads 66 and 67 are connected to the measuring device 71. With the measuring device 71 thus connected to the pads drawn from the layers, the insulation characteristic of which is to be measured, the insulation characteristic can be measured.

The above-described embodiments have been specifically described for better understanding of the present invention, and thus do not limit other embodiments. Therefore, alternations can be made within a scope not changing the gist of the invention. For example, the present invention may be configured such that the characteristic of the magnetic head element can be measured by measuring the insulation monitoring element in terms of the SN characteristic or the magnetization characteristic, for example.

What is claimed is:

1. A wafer comprising:
a plurality of magnetic head elements having:
an upper magnetic layer;
a lower magnetic layer electrically connected with the upper magnetic layer;
an insulating layer located between the upper magnetic layer and the lower magnetic layer; and
a coil layer composed of a conductive material, formed in the insulating layer; and
at least one magnetic head monitor element having:
an upper magnetic layer;
a lower magnetic layer;
an insulating layer located between the upper magnetic layer and the lower magnetic layer; and
a coil layer composed of a conductive material, formed in the insulating layer;
the upper magnetic layer of said monitor element being electrically separated from the lower magnetic layer.

2. The wafer of claim 1,
wherein said monitor element, the upper magnetic layer of said monitor element being separated by the insulating layer from the coil layer.

3. The wafer of claim 1,
wherein said monitor element, the coil layer of said monitor element being separated by the lower magnetic layer.

4. The wafer of claim 1,
wherein said monitor element, the coil layer including an upper coil layer and a lower coil layer; and the upper coil layer of said monitor element being separated by the insulating layer from the lower coil layer.

5. An insulation characteristic monitoring method for monitoring insulation of magnetic head elements on a wafer, the method comprising:
providing a plurality of magnetic head elements on said wafer, each of said magnetic heads having:
an upper magnetic layer;
a lower magnetic layer electrically connected with the upper magnetic layer;
an insulating layer located between the upper magnetic layer and the lower magnetic layer; and
a coil layer composed of a conductive material, formed in the insulating layer; and
providing at least one magnetic head monitor element having:
an upper magnetic layer;
a lower magnetic layer;
an insulating layer located between the upper magnetic layer and the lower magnetic layer; and
a coil layer composed of a conductive material, formed in the insulating layer;
the upper magnetic layer of said magnetic head monitor element being electrically separated from the lower magnetic layer; and
measuring an insulation characteristic of said monitor element to monitor insulation of the magnetic head elements.

6. The insulation characteristic monitoring method of claim 5, wherein measuring measures an insulation characteristic between the upper magnetic layer of said monitor element and the lower magnetic layer.

7. The insulation characteristic monitoring method of claim 5, wherein the providing provides said monitor element, the upper magnetic layer of said monitor element being separated by the insulating layer from the coil layer; and
the measuring measures an insulation characteristic between the upper magnetic layer of said monitor element and the coil layer.

8. The insulation characteristic monitoring method of claim 5, wherein the providing provides said monitor element, the coil layer of said monitor element being separated by the insulating layer from the lower magnetic layer; and
the measuring measures an insulation characteristic between the coil layer of said monitor element and the lower magnetic layer.

9. The insulation characteristic monitoring method of claim 5, wherein the providing provides said monitor element, the coil layer including an upper coil layer and a lower coil layer; the upper coil layer of said monitor element being separated by the insulating layer from the lower magnetic layer; and
the measuring measures an insulation characteristic between the upper coil layer of said monitor element and the lower coil layer.
